(19) United States
(12) Patent Application Publication
(10) Pub. No.: US 2004/0101205 A1
(43) Pub. Date: May 27, 2004

(54) Position coding system and method

(75) Inventors: Somasekhar Dhavala, Bangalore (IN); Frederick Wilson Wheeler, Latham, NY (US); Sudipta Mukhopadhyay, Bangalore (IN); Nithin Nagaraj, Bangalore (IN)

Correspondence Address: General Electric Company, CRD Patent Docket Rm 4A59, P.O. Box 8, Bldg. K-1, Schenectady, NY, 12301, US

(73) Assignee: General Electric Company

(21) Appl. No.: 10/306,442

(22) Filed: Nov. 27, 2002

(51) Int. Cl. G06K 9/36

(52) U.S. Cl. 382/247

(57) ABSTRACT

A data coding system is provided for coding an uncompressed data and decoding the coded data. The data coding system comprises a position coding system for defining a context based upon a position of a most significant bit in the uncompressed data and a context value, an encoder for encoding the context to generate an encoded context and compiling the uncompressed data based on the encoded context and remaining bits of the uncompressed data to generate a coded data, and a decoder for decoding the coded data to generate a decoded data.

### BACKGROUND

The invention relates generally to data compression techniques, and more specifically to a method and apparatus for coding data according to the position of a significant bit.

Compression refers to representing data using a minimum number of bits. Broadly, compression of data is of two types, namely, lossy and lossless compression. Lossless compression of data refers to that which can be completely recovered when decompressed without losing any data. Typically, in many applications, lossless compression is desirable, especially in medical images. With the increase in resolution and/or dimensionality of the data to be processed, the time required by the compression and decompression algorithms simultaneously increase.

It would therefore be desirable to design a codec (coder/decoder) for compressing and decompressing large data while maintaining low complexity and a good compression ratio.

### BRIEF DESCRIPTION

Briefly, in accordance with one embodiment of the present technique, a method for coding an uncompressed data and decoding coded data is provided. The method comprises defining a bin based upon a position of a most significant bit in the uncompressed data and a context value, encoding a context to generate an encoded context, compiling the uncompressed data based on the encoded context and remaining bits of the data to generate the coded data, and decoding the coded data to generate a decoded data.

In another embodiment, a data coding system for coding an uncompressed data and decoding a coded data is provided. The data coding system comprises a position coding system for defining a bin based upon a position of a most significant bit in the uncompressed data and a context value, an encoder for encoding a context to generate an encoded context and compiling the uncompressed data based on the encoded context and remaining bits of the uncompressed data to generate a coded data, and a decoder for decoding the coded data to generate a decoded data.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic view of an embodiment of a data coding system;

FIG. 2 is an example of an 8-bit data;

FIG. 3 is a flow chart illustrating the manner in which the 8-bit data is encoded using position coding;

FIG. 4 is a flow chart illustrating the manner in which the 8-bit data is decoded using position coding;

FIG. 5 is a diagrammatic representation of a general-purpose computer system used in accordance with preferred embodiments of the invention; and

FIG. 6 is a diagrammatic representation of an exemplary imaging system utilizing a preferred implementation of the present invention.

### DETAILED DESCRIPTION

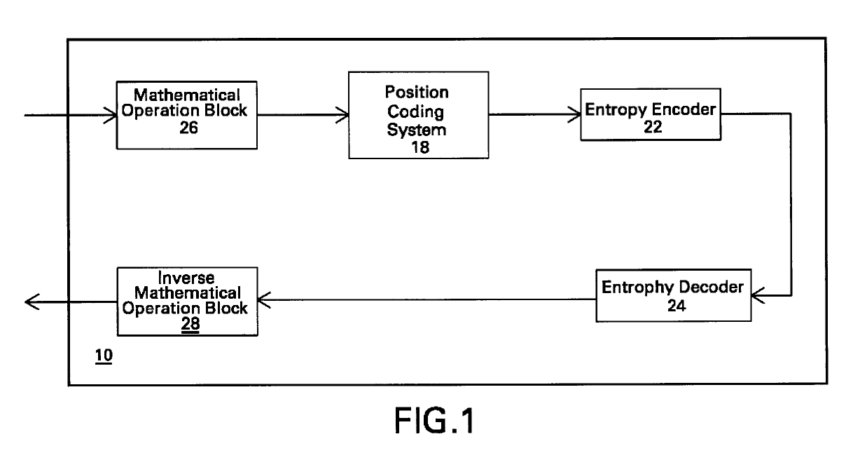

FIG. 1 is a diagrammatic view of an embodiment of data coding system 10 for coding an uncompressed data and decoding a coded data. The data coding system is shown comprising position coding system 18, entropy encoder 22, entropy decoder 24, mathematical operation block 26 and inverse mathematical operation block 28. Each block is described in further detail below.

Mathematical operation block 26 receives the uncompressed data and performs a mathematical operation on the uncompressed data. In the illustrated embodiment, a wavelet transform operation is performed on the uncompressed data to generate a transformed data. Alternate mathematical operations include prediction operation, quantization, etc. In the illustrated embodiment, uncompressed data represents an image.

Position coding system 18 receives the transformed data and defines a context based upon a position of a most significant bit and a context value. In one embodiment, the context value is a constant value for an entire image. In another embodiment, the context value is a first variable for a first part of an image and a second variable for a second part of an image.

Encoder 22 encodes the context to generate an encoded context and compiles the uncompressed data based on the encoded context and a RAW data to generate a coded data. The RAW data refers to the remaining bits of the uncompressed data. In one embodiment, encoder 22 comprises an entropy encoder, which uses the entropy encoding technique for encoding. In another embodiment, the encoder encodes the remaining bits of the uncompressed data. Decoder 24 decodes the coded data to generate a decoded data. In one embodiment, decoder 22 comprises an entropy decoder. In an embodiment, the decoded data is passed to a position decoding block (not shown), which performs the decoding of the context based on the context value and the position of the most significant bit.

Inverse mathematical operation block 28 performs an inverse mathematical operation on the decoded data to generate inverse transformed data. In an embodiment, the inverse mathematical operation comprises an inverse wavelet transform operation. Other inverse mathematical operations include prediction, quantization, etc. It may be noted that the mathematical operation block and the inverse mathematical operation block are optional and that the uncompressed data can be provided directly to the encoder.

As described earlier, the position coding system defines a context based on the position of a first non-zero most significant bit (MSB) in the uncompressed data and a context value. The context value represents the number of bit planes that are coded after the MSB.

For example, if the uncompressed data has 256 data values, the total number of positions equals 9. The term position here refers to the position or location of the first non-zero MSB. It must be noted that in an eight-bit data there are 9 positions instead of 8, which includes MSB of data value representing “0”. The data value equal to “0” does not have any MSB, hence, 0's MSB occurs in 0th position.

TABLE 1
below represents various bin formation if the context value
equals zero. For simplicity, the letter ‘M’ represents
the context value.

| | | | | | | | | | MSB position |
|---|---|---|---|---|---|---|---|---|---|
| Data Value | B8 | B7 | B6 | B5 | B4 | B3 | B2 | B1 | (Bin no.) |
| 0 | 0 | 0 | 0 | 0 | 0 | 0 | 0 | 0 | 0 |
| 1 | 0 | 0 | 0 | 0 | 0 | 0 | 0 | 1 | 1 |
| 2 | 0 | 0 | 0 | 0 | 0 | 0 | 1 | 0 | 2 |
| 3 | 0 | 0 | 0 | 0 | 0 | 0 | 1 | 1 | 2 |
| 4 | 0 | 0 | 0 | 0 | 0 | 1 | 0 | 0 | 3 |
| 7 | 0 | 0 | 0 | 0 | 0 | 1 | 1 | 1 | 3 |
| 8 | 0 | 0 | 0 | 0 | 1 | 0 | 0 | 0 | 4 |
| 15 | 0 | 0 | 0 | 0 | 1 | 1 | 1 | 1 | 4 |
| 16 | 0 | 0 | 0 | 1 | 0 | 0 | 0 | 0 | 5 |
| 31 | 0 | 0 | 0 | 1 | 1 | 1 | 1 | 1 | 5 |
| 32 | 0 | 0 | 1 | 0 | 0 | 0 | 0 | 0 | 6 |
| 63 | 0 | 0 | 1 | 1 | 1 | 1 | 1 | 1 | 6 |

Thus, the context is derived from the position of the first non-zero bit in the data value. Thus, when data value equal to 32 needs to be transmitted, based on the context, only ‘6’ needs to be transmitted since context 6 represents any data value from 32 to 63. The bin formation may be altered according to the context value. An example is shown below for M=1.

| | | | | | | | | | MSB | |
|---|---|---|---|---|---|---|---|---|---|---|
| Symbol | B8 | B7 | B6 | B5 | B4 | B3 | B2 | B1 | position | Context |
| 0 | 0 | 0 | 0 | 0 | 0 | 0 | 0 | 0 | 0 | 0 |
| 1 | 0 | 0 | 0 | 0 | 0 | 0 | 0 | 1 | 1 | 1 |
| 2 | 0 | 0 | 0 | 0 | 0 | 0 | 1 | 0 | 2 | 2 |
| 3 | 0 | 0 | 0 | 0 | 0 | 0 | 1 | 1 | 2 | 3 |
| 4 | 0 | 0 | 0 | 0 | 0 | 1 | 0 | 0 | 3 | 4 |
| 7 | 0 | 0 | 0 | 0 | 0 | 1 | 1 | 1 | 3 | 5 |
| 8 | 0 | 0 | 0 | 0 | 1 | 0 | 0 | 0 | 4 | 6 |
| 15 | 0 | 0 | 0 | 0 | 1 | 1 | 1 | 1 | 4 | 7 |
| 16 | 0 | 0 | 0 | 1 | 0 | 0 | 0 | 0 | 5 | 8 |
| 31 | 0 | 0 | 0 | 1 | 1 | 1 | 1 | 1 | 5 | 9 |
| 32 | 0 | 0 | 1 | 0 | 0 | 0 | 0 | 0 | 6 | 10 |
| 63 | 0 | 0 | 1 | 1 | 1 | 1 | 1 | 1 | 6 | 11 |

From the above table, it is observed that the number of bins has increased. Thus, context 11 refers to data value that has the first non-zero MSB in 6th position and the next bit is 1. Similarly, context 10 represents data values ranging from 32 to 47 and bin 11 represents data values ranging from 48 to 63. In general, the total member of bins are determined using the following equation:

$$1 + {\sum }_{i = 0}^{M} {2}^{i} + ( bit\_depth - M - 1 ) {2}^{M} \qquad Equation ( 1 )$$

where bit_depth refers to bit depth, which in turn means the maximum number of bit planes that can be occupied by any data value.

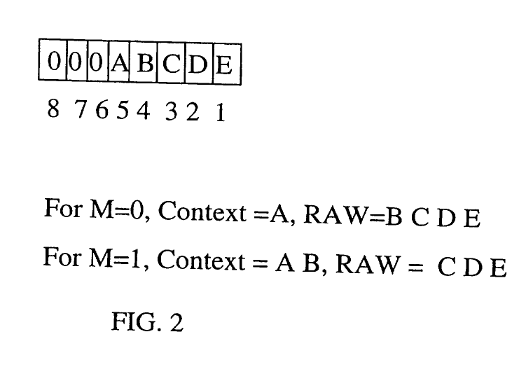

An example of an 8 bit data is shown in FIG. 2. The uncompressed data equals ‘000ABCDE’. The bit depth for the data is 8. The total number of bins is given by Equation (1). An ‘OFFSET’ is also chosen as given by the following equation:

$$OFFSET = {\sum }_{i = 0}^{M} {2}^{i} \qquad Equation ( 2 )$$

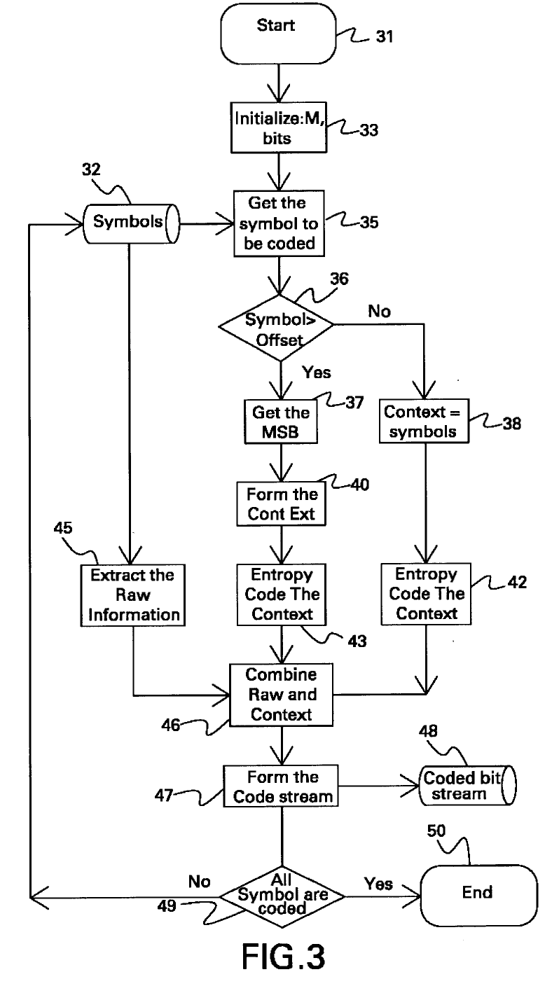

Typically, the OFFSET is calculated for a value of M. For example, when M=0, OFFSET is 1. Thus, for a context value (M) of 0, the total number of bins equals 9, context equals ‘A’, and the remaining bits form the RAW information or RAW equals B C D E. Similarly, if context value equals 1, context equals ‘A B’, and RAW equals C D E. Context value refers to the number of bit-planes to be coded after the MSB. The manner in which the uncompressed data is encoded is described in further detail using FIG. 3.

The flow chart for encoding is shown in FIG. 3. The encoding process starts at step 31 and control immediately passes on to step 33.

In step 33, a context value is selected which is set for both the encoder and the decoder. In addition, the bit depth for the uncompressed data is also determined. In step 35, one data value of the uncompressed data is obtained which has to be coded.

In step 36, a comparison is made to determine if the data value is greater than or equal to or less than the OFFSET. If the data value is lesser than or equal to OFFSET then, context equals the uncompressed data value and the context is coded. In one embodiment, the context is coded using an entropy coder implementing Huffman coding or arithmetic coding. It may be noted that RAW does not exist in the above case. The control immediately passes on to step 42.

If the data value is greater than OFFSET, then the MSB of the uncompressed data is extracted as shown in step 37. In step 40, the context is generated from the position of the MSB and the context value. In step 43 the context is encoded and in step 45, RAW is determined. In step 46, the context and the RAW are combined. In step 47, a code stream is formed comprising the coded CONTEXT and the RAW. If the data value is less than the OFFSET, the context equals the symbol, or in other words RAW is absent and the context is coded as shown in step 42.

In one embodiment, RAW is coded using an entropy encoder. The code stream is then transmitted as desired. In step 49, it is checked to determine if all the data values in the uncompressed data have been encoded. If all the data values are not encoded, control passes to step 35, else the process ends at step 50. An example is illustrated below.

Let us assume that a data value of 11 needs to be encoded. The data value is represented by ‘x’. The bit pattern of the data value is ‘0 1 0 1 1’ and the bit depth equals 5. The context value ‘M’ is initialized to 2 and OFFSET as determined by equation (2) and is equal to 7. Thus, the total number of bins is given by Equation (1) and is equal to 16. Since OFFSET is less than the data value, the MSB position is extracted.

After, the position of the MSB is extracted, the next 2 bit positions following the MSB position are also extracted since M equals to 2. In this case it is the bit positions of ‘01’. The decimal value of ‘01’ is 1. The decimal value is assigned to a variable ‘VAL’. The context is determined as (MSB_position-M)*2´M+VAL, which is 2*4+1=9, where ‘*’ is the multiplication operation.

The next step is to extract the remaining bits or RAW. In the example, RAW equals 1. The context is encoded and combined with the RAW to generate the coded bit stream. In one embodiment, the RAW is also encoded.

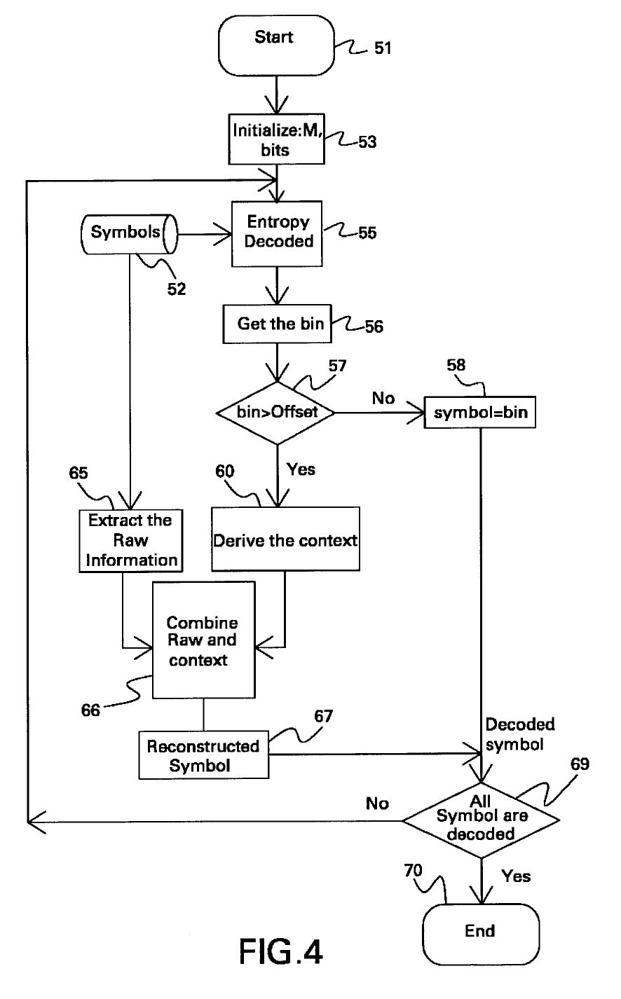

The flow chart for decoding is shown in FIG. 4. The decoding process starts at step 51 and control immediately passes on to step 53. In step 53, the context value is selected which was initially set for the encoder. In step 55, one coded data value of the coded bit stream is obtained which has to be decoded. In step 55, the coded data value is decoded and in step 36, the context is obtained. In step 57, a comparison is made to determine if the context is greater than or equal to or less than the OFFSET.

If the context is less than or equal to OFFSET then, context equals the data value of the uncompressed data as shown in step 58. On the other hand, if the context is greater than the OFFSET, the context is derived as shown in step 60, and then the RAW is extracted from the coded bit stream as shown in step 65.

In step 66, the RAW and context is combined to form the data value and the reconstructed data value is generated in step 67. In step 69, it is determined if all the data values have been decoded and if all data values have been decoded, the process ends at step 70, else control passes to step 55, where a next data value is decoded. As an example, the manner in which context of the previous example is decoded is described below.

Since the context is greater than OFFSET (7) the position of the MSB is determined to extract the bin information. The MSB position is determined by using the following equation:

MSB_position=Context/2´M+M. Equation (3)

Thus, MSB_position=[9/4]+2=4 where the square brackets indicate integer division.

Next, (MSB_position)-M−1 bit-planes is determined and the result is sufficiently shifted to arrive at an approximate data value. The approximate data value is assigned a variable ‘img’.

Thus, img is determined by the following equation:

img=(bin−(MSB_{—}position−M−1).2´M). 2´(MSB_{—}position−M−1)

img=(9−(4−2−1).2´2). 2´(4−2−1)=(9−4). 2´(4−2−1)=10₁₀ Equation (4)

Similarly, the (MSB_position)−M−1 bits of raw information from the raw stream is determined.

Thus, number of raw bits=(MSB_position)−M−1.

Thus, raw=1.

The data value ‘x’ is determined by the following equation:

x=img+raw Equation (5)

x=10+1=11

It may be noted that data in general have different representations in different ‘bases’ or ‘radixes’. The above description relates to binary data or base 2. The ‘position’ of the non-zero ‘MSB’ of data are different in different radix or bases. Thus, when uncompressed data is represented in different radix, the ‘position’ of the MSB changes, thus changing the context and the RAW. In general, the length of the bins changes as an exponent of power-N where ‘N’ is the radix or base of the uncompressed data representation. An example is illustrated below.

Consider 8-bit unsigned uncompressed data with a range from 0-255. In radix-3, 255 is mapped to 100110. Thus, 6 ‘trits’ are sufficient to represent all numbers from 0-255 in base-3. It may be noted that in base-3, the number of symbols equals 3, (for example, 0, 1 and 2) unlike base-2 where only two symbols are used (0 and 1). The below table illustrates an example, 42 in base 10 which is mapped to 1120 in base-3.

| Data values | T6 | T5 | T4 | T3 | T2 | T1 | MSB position | Context |
|---|---|---|---|---|---|---|---|---|
| 0 | 0 | 0 | 0 | 0 | 0 | 0 | 0 | 0 |
| 1 | 0 | 0 | 0 | 0 | 0 | 1 | 1 | 1 |
| 2 | 0 | 0 | 0 | 0 | 0 | 2 | 1 | 2 |
| 3-5 | 0 | 0 | 0 | 0 | 1 | X | 2 | 3 |
| 6-8 | 0 | 0 | 0 | 0 | 2 | X | 2 | 4 |
| 9-17 | 0 | 0 | 0 | 1 | X | X | 3 | 5 |
| 18-26 | 0 | 0 | 0 | 2 | X | X | 3 | 6 |
| 27-53 | 0 | 0 | 1 | X | X | X | 4 | 7 |
| 54-80 | 0 | 0 | 2 | X | X | X | 4 | 8 |
| 81-161 | 0 | 1 | X | X | X | X | 5 | 9 |
| 162-242 | 0 | 2 | X | X | X | X | 5 | 10 |
| 243-484 | 1 | X | X | X | X | X | 6 | 11 |
| 485-728 | 2 | X | X | X | X | X | 6 | 12 |

A Huffman coding system or an adaptive arithmetic coding system can be used to code the contexts and the raw-information can be sent uncoded or coded as desired. It may be noted that the RAW comprises ‘trits’ i.e. 3 data values 0, 1 and 2.

The above illustrations are directed to base 2 and base 3 but the concept can be extended to base-n, as may be appreciated by one skilled in the art.

The above methods of coding uncompressed data based upon the position of the most significant bit in the data can be implemented using a computer system. The manner in which the desired bin structure is generated using a computer system is described below in further detail.

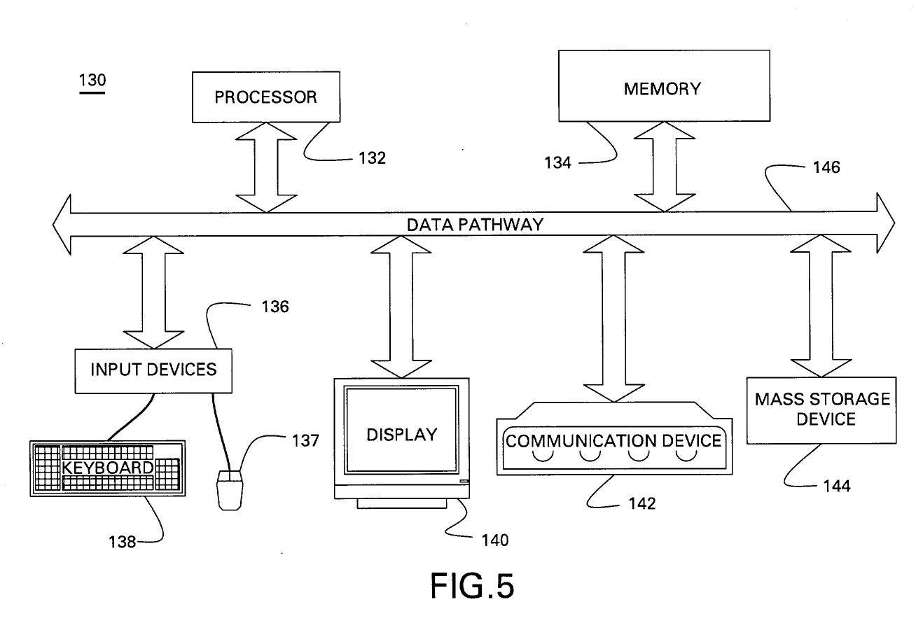

FIG. 5 shows a schematic of a general-purpose computer system 130 which may be used to code uncompressed data based upon the position of the most significant bit in the data as described in the above method. Computer system 130 generally comprises at least one processor 132, memory 134, input/output devices 136, and data pathways (e.g., buses) 146 connecting the processor, memory and input/output devices. Processor 132 accepts instructions and data from memory 134 and performs various operations such as implementing the position coding algorithm as described in the flow charts above. Processor 132 includes an arithmetic logic unit (ALU) that performs arithmetic and logical operations and a control unit that extracts instructions from memory 134 and decodes and executes them, calling on the ALU when necessary. The memory generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, memory 134 preferably comprises an operating system, which executes on the processor 132. The operating system performs basic tasks that include recognizing input, sending output to output devices, keeping track of files and directories and controlling various peripheral devices.

The input/output devices may comprise keyboard 138 and mouse 137 that enable a user to enter data and instructions into the computer system. Also, display 140 may be used to allow a user to see what the computer has accomplished. Other output devices may include a printer, plotter, synthesizer and speakers. Communication device 142 such as a telephone or cable modem or a network card such as an Ethernet adapter, local area network (LAN) adapter, integrated services digital network (ISDN) adapter, or Digital Subscriber Line (DSL) adapter, that enables the computer system 130 to access other computers and resources on a network such as a LAN or a wide area network (WAN).

Mass storage device 144 may be used to allow the computer system to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 130 can take the form of a hand-held digital computer, personal digital assistant computer, notebook computer, personal computer, workstation, mini-computer, mainframe computer or supercomputer.

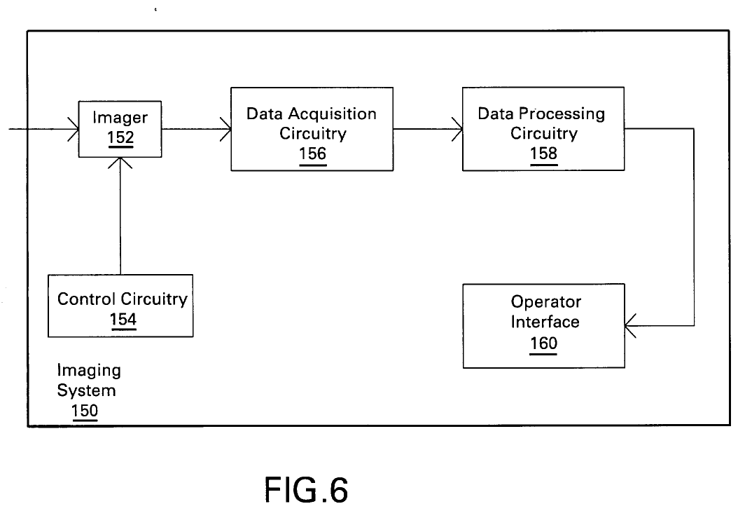

As described hereinabove, the method for coding data based upon the position coding algorithm can be applied to medical images. FIG. 6 provides a general overview for exemplary imaging systems to which position coding algorithm can be applied in accordance with the embodiments of the present invention.

Imaging system 150 generally includes some type of imager 152 that detects image data or signals and converts the signals to useful data. As described more fully below, the imager 152 may operate in accordance with various physical principles for creating the image data. In general, however, image data indicative of regions of interest in a patient are created by the imager either in a conventional support, such as photographic film, or in a digital medium.

The imager operates under the control of system control circuitry 154. The system control circuitry may include a wide range of circuits, such as radiation source control circuits, timing circuits, circuits for coordinating data acquisition in conjunction with patient or table of movements, circuits for controlling the position of radiation or other sources and of detectors, and so forth.

The imager 152, following acquisition of the image data or signals, may process the signals, such as for conversion to digital values, and forwards the image data to data acquisition circuitry 156. In the case of analog media, such as photographic film, the data acquisition circuitry may generally include supports for the film, as well as equipment for developing the film and producing hard copies. For digital systems, the data acquisition circuitry 156 may perform a wide range of initial processing functions, such as adjustment of digital dynamic ranges, smoothing or sharpening of data, as well as compiling of data streams and files, where desired.

The data is then transferred to data processing circuitry 158 where additional processing and analysis are performed. For conventional media such as photographic film, the data processing circuitry may apply textual information to films, as well as attach certain notes or patient-identifying information. For the various digital imaging systems available, the data processing circuitry perform substantial analyses of data, ordering of data, sharpening, smoothing, feature recognition, and so forth.

Ultimately, the image data is forwarded to some type of operator interface 160 for viewing and analysis. While operations may be performed on the image data prior to viewing, the operator interface 160 is at some point useful for viewing reconstructed images based upon the image data collected. It should be noted that in the case of photographic film, images are typically posted on light boards or similar displays to permit radiologists and attending physicians to more easily read and annotate image sequences. The images may also be stored in short or long term storage devices, for the present purposes generally considered to be included within the interface 160, such as picture archiving communication systems. The image data can also be transferred to remote locations, such as via a network.

It should also be noted that, from a general standpoint, the operator interface 160 affords control of the imaging system, typically through interface with the system control circuitry 154. Moreover, it should also be noted that more than a single operator interface 160 may be provided. Accordingly, an imaging scanner or station may include an interface which permits regulation of the parameters involved in the image data acquisition procedure, whereas a different operator interface may be provided for manipulating, enhancing, and viewing resulting reconstructed images.

The primary benefit of position coding method is that size of the symbol set, which is to be encoded by the entropy encoder, is greatly reduced which result in faster encoding and decoding. The entropy coder is applied only to the context, so the size of the symbol set is reduced. Thus, the entropy coder requires smaller memory tables and less computation time. Position coding is designed in such a way that this computational efficiency is achieved such that the affect on compression ratio is small.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for coding uncompressed data, the method comprising:
defining a context based upon a position of a most significant bit in the uncompressed data and a context value;
encoding the context to generate an encoded context; and
compiling the uncompressed data based on the encoded context and remaining bits of the uncompressed data.

2. The method of claim 1, wherein the context value is a constant value for an entire image.

3. The method of claim 1, wherein the context value is a first variable for a first part of an image and a second variable for a second part of an image.

4. The method of claim 1, wherein encoding comprises entropy encoding.

5. The method of claim 1 further comprising, performing a mathematical operation on the uncompressed data.

6. The method of claim 1, wherein the uncompressed data is represented by ‘n’ radixes, wherein ‘n’ is an integer.

7. The method of claim 1 further comprising, encoding the remaining bits of the uncompressed data.

8. The method of claim 1, wherein the uncompressed data represents an image.

9. A method for coding uncompressed data, the method comprising:
defining a context based upon a position of a most significant bit in the uncompressed data and a context value;
encoding the context to generate an encoded context using entropy encoding;
encoding remaining bits of the uncompressed data using entropy encoding;
compiling the uncompressed data based on the encoded context and encoded remaining bits of the uncompressed data.

10. The method of claim 9, wherein the context value is a constant value for an entire image.

11. The method of claim 9, wherein the context value is a first variable for a first part of an image and a second variable for a second part of an image.

12. The method of claim 9 further comprising, performing a mathematical operation on the uncompressed data.

13. The method of claim 9, wherein the uncompressed data is represented by ‘n’ radixes, wherein ‘n’ is an integer.

14. The method of claim 1, wherein the uncompressed data represents an image.

15. A method for coding an uncompressed data and decoding coded data, the method comprising:
defining a context based upon a position of a most significant bit in the uncompressed data and a context value;
encoding the context to generate an encoded context;
compiling the uncompressed data based on the encoded context and remaining bits of the uncompressed data to generate the coded data; and
decoding the coded data to generate a decoded data.

16. The method of claim 15, wherein the context value is a constant value for an entire image.

17. The method of claim 15, wherein the context value is a first variable for a first part of an image and a second variable for a second part of an image.

18. The method of claim 15, wherein encoding comprises entropy encoding and decoding comprises entropy decoding.

19. The method of claim 15 further comprising,
performing a mathematical operation on the uncompressed data; and
performing an inverse mathematical operation on the decoded data.

20. The method of claim 15, wherein the uncompressed data is represented in n radixes, wherein ‘n’ is an integer.

21. The method of claim 15 further comprising, encoding the remaining bits of the uncompressed data.

22. The method of claim 15, wherein the uncompressed data represents an image.

23. A data coding system for coding an uncompressed data and decoding a coded data, the data coding system comprising:
a position coding system configured for defining a context based upon a position of a most significant bit in the uncompressed data and a context value;
an encoder configured for encoding the context to generate an encoded context and compiling the uncompressed data based on the encoded context and remaining bits of the uncompressed data to generate a coded data; and
a decoder configured for decoding the coded data to generate a decoded data.

24. The data coding system of claim 23, wherein the context value is a constant value for an entire image.

25. The data coding system of claim 23, wherein the context value is a first variable for a first part of an image and a second variable for a second part of an image.

26. The data coding system of claim 23, wherein encoding comprises an entropy encoder and decoding comprises an entropy decoder.

27. The data coding system of claim 23 further comprising,
a mathematical operation block configured for performing a mathematical operation on the uncompressed data; and
an inverse mathematical operation block configured for performing an inverse mathematical operation on the decoded data.

28. The data coding system of claim 23, wherein the uncompressed data is represented in n radixes, wherein ‘n’ is an integer.

29. The data coding system of claim 23 wherein the encoder encodes the remaining bits of the uncompressed data.

30. The data coding system of claim 23, wherein the uncompressed data represents an image.

31. A system for coding an uncompressed data and decoding a coded data, the system comprising:
means for defining a context based upon a position of a most significant bit in the uncompressed data and a context value;
means for encoding the context to generate an encoded context and means for compiling the uncompressed data based on the encoded context and remaining bits of the uncompressed data to generate the coded data; and
means for decoding the coded data to generate a decoded data.

32. The system of claim 31, wherein the context value is a constant value for an entire image.

33. The of claim 31, wherein the context value is a first variable for a first part of an image and a second variable for a second part of an image.

34. The system of claim 31 further comprising,
means for performing a mathematical operation on the uncompressed data; and
means for performing an inverse mathematical operation on the decoded data.

35. The system of claim 31 further comprising means for encoding the remaining bits of the uncompressed data.

36. The system of claim 31, wherein the uncompressed data represents an image.

37. The system of claim 31, wherein the uncompressed data is represented in n radixes, wherein ‘n’ is an integer.
